(19) United States
(12) Patent Application Publication
(10) Pub. No.: US 2006/0108016 A1
(43) Pub. Date: May 25, 2006

(54) Resin-lined steel pipe and method for production thereof

(76) Inventors: Shinichi Funatsu, Chiba (JP); Hiroyuki Mimura, Chiba (JP); Yoshihisa Kariyazono, Chiba (JP)

Correspondence Address: KENYON & KENYON LLP, ONE BROADWAY, NEW YORK, NY, 10004, US

(21) Appl. No.: 10/523,188

(22) PCT Filed: Jul. 30, 2003
(86) PCT No.: PCT/JP03/09697

§ 371 Date: Aug. 30, 2005

(30) Foreign Application Priority Data
Jul. 31, 2002 (JP) 2002-222559
Apr. 24, 2003 (JP) 2003-119383

(51) Int. Cl. F16L 9/14

(52) U.S. Cl. 138/141; 428/36.9; 428/36.91; 138/143

(57) ABSTRACT

A plastic lined steel pipe characterized by having an adhesive layer on an inner surface of a steel pipe, having a plastic layer on its further inner side, and having an initial shearing adhesion strength between the steel pipe and the plastic layer of 2.0 MPa or more, said steel pipe being a steel pipe given substrate treatment on its inner surface in advance, said substrate treatment comprising forming a phosphate chemical treatment coating treated for grain refinement, and preferably having an epoxy primer layer between the steel pipe and the adhesive layer. A method for producing a plastic lined steel pipe characterized by inserting a plastic pipe having an outside diameter smaller than the inside diameter of the steel pipe subjected to the substrate treatment and having an adhesive layer on its outer surface into the steel pipe, reducing the outside diameter of the steel pipe so as to make the plastic pipe closing contact it, and heating the result at a temperature not less than a melt end temperature of the adhesive layer and less than a melt start temperature of the plastic pipe.

### TECHNICAL FIELD

The present invention relates to a plastic lined steel pipe used for piping etc. for water supply, hot water supply, air-conditioning, firefighting, drainage, etc. and a method for producing the same, in more detail relates to a plastic lined steel pipe excellent in adhesion between the steel pipe and the inner surface plastic lining layer over a long period even at cold locations and a method for producing the same.

### BACKGROUND ART

As the material of piping for transporting water etc., other than steel pipes such as forged steel pipes and seam-welded steel pipes, polyvinyl chloride, polyethylene, polypropylene, polybutene, and other thermoplastic plastic pipes are being used. Steel pipes have larger mechanical strengths in comparison with these plastic pipes, therefore have higher shock resistance at the time of installation and have excellent compression resistance even when buried under heavy traffic roads. Even when the temperature of the transported fluid is high, the pipes are sufficiently large and excellent in compression strength when compared with plastic pipes and hard to burn unlike plastic pipes, so will not burn by fire even when used for indoor purposes.

However, in applications requiring prevention of clouding of the fluid and the prevention of clogging of the pipeline due to the corrosion of the steel, use is made of plastic pipe not subject to corrosion. As a piping material having the merits of both, a composite pipe of plastic and steel prevented from corrosion by inserting a plastic pipe into the inner surface of a steel pipe is known. For example, as a water pipe and drainage pipe, a composite pipe of steel and a soft polyvinyl chloride making good use of cheap polyvinyl chloride is being widely used, while as a hot water pipe, a composite pipe of steel and a hard polyvinyl chloride is being widely used.

When using a polyvinyl chloride material, however, there is also the problem that dioxins are produced when incinerating the remaining pieces of composite pipes produced in on-site piping work. Accordingly, as the composite pipes used for water pipes, hot water pipes, drainage pipes, etc., pipes not using polyvinyl chloride have been desired.

Therefore, Japanese Unexamined Patent Publication (Kokai) No. 2001-9912 and Japanese Unexamined Patent Publication (Kokai) No. 2001-9913 disclose the method of lining the inside surface of a steel pipe by utilizing the shape memory of a polyolefin resin or cross-linked polyolefin resin free from the problem of production of dioxins to restore by heat a polyolefin plastic pipe or cross-linked polyolefin plastic pipe reduced in diameter from the inside diameter of the steel pipe.

When lining the inside surface of a steel pipe by a polyolefin plastic pipe or a cross-linked polyolefin plastic pipe by the method disclosed in Japanese Unexamined Patent Publication (Kokai) No. 2001-9912 and Japanese Unexamined Patent Publication (Kokai) No. 2001-9913, however, since a polyolefin resin or a cross-linked polyolefin resin is much larger in thermal shrinkage than steel in comparison with a polyvinyl chloride, in the final cooling step of the production, the outside diameter of the polyolefin plastic pipe or the cross-linked polyolefin plastic pipe tends to become smaller than the inside diameter of the steel pipe, so a large peeling force acts at the interface between the steel pipe and the polyolefin plastic pipe or the cross-linked polyolefin plastic pipe. For this reason, in a composite pipe of steel and a polyolefin resin or a cross-linked polyolefin resin, a peeling stress constantly acts upon the interface between the steel pipe and the plastic pipe. Therefore, even in a case where an adhesive, an epoxy primer, or a chemical treatment coating is used for preventing peeling, if this is used for piping for water supply, hot water supply, air-conditioning, firefighting, drainage, etc. over a long period, the bonded interface between the steel pipe and the polyolefin plastic pipe or the cross-linked polyolefin plastic pipe deteriorates and the adhesion strength becomes weak, so there was the problem that the polyolefin plastic pipe or the cross-linked polyolefin plastic pipe would peel off from the inner surface of the steel pipe due to the shrinkage stress inherent in the polyolefin plastic pipe or the cross-linked polyolefin plastic pipe. Further, when considering use at cold locations, the polyolefin resin or the cross-linked polyolefin resin further tends to shrink and the peeling force to become larger. It was learned that a chemical treatment coating was not durable against that and ended up breaking.

### DISCLOSURE OF THE INVENTION

In consideration with the above problems, the present invention provides a plastic lined steel pipe used for piping for water supply, hot water supply, air-conditioning, firefighting, drainage, etc. which is excellent in adhesion between the steel pipe and the inner surface plastic lining layer over a long period even at cold locations and a method for producing the same.

The inventors took note of polyolefin resins and cross-linked polyolefin resins which are free from the problem of production of dioxins. Further, since these resins have a thermal shrinkage far larger than that of steel in comparison with polyvinyl chloride, they proposed not to utilize the shape memory property. Namely, in the method of lining the inside surface by restoring by heating a plastic pipe reduced in diameter to be smaller than the inside diameter of the steel pipe, the outside diameter of the plastic pipe tends become smaller than the inside diameter of the steel pipe in the final cooling step of the production, so a large peeling force acts upon the interface of the steel pipe and the plastic pipe. The present invention was made by the discovery that by conversely drawing the steel pipe so as to line the inside surface while leaving an expansion force whereby the plastic pipe tries become larger in outside diameter than the inside diameter of the steel pipe and further providing between the steel pipe and the plastic pipe an adhesive layer and a phosphate chemical treatment coating treated for grain refinement to reinforce the adhesion and, according to need, providing an epoxy primer layer, a plastic lined steel pipe excellent in adhesion between the steel pipe and the inner surface plastic lining layer over a long period even at cold locations and usable for piping for water supply, hot water supply, air-conditioning, firefighting, drainage, etc. was possible. The gist thereof is as follows:

(1) A plastic lined steel pipe characterized by having an adhesive layer on an inner surface of a steel pipe or a steel pipe galvanized on its outer surface, having a plastic layer on its further inner side, and having an initial shearing adhesion strength between the steel pipe and the plastic layer of 2.0 MPa or more, said steel pipe being a steel pipe given substrate treatment on its inner surface in advance, said substrate treatment comprising forming a phosphate chemical treatment coating treated for grain refinement.

Here, the “initial shearing adhesion strength” means the adhesion strength between the steel pipe and the plastic layer after adhesion and before use. When this initial shearing adhesion strength is less than 2.0 MPa, the resin lining is liable to peel off during use, so the initial shearing adhesion strength must be 2.0 MPa or more, preferably 4.0 MPa or more.

(2) A plastic lined steel pipe as set forth in the above (1), wherein said plastic layer is a polyolefin resin or a cross-linked polyolefin resin.

(3) A plastic lined steel pipe as set forth in the above (1) or (2) wherein said adhesive layer is comprised of one or more of a maleic anhydride-modified polyolefin, itaconic anhydride-modified polyolefin, ethylene/maleic anhydride copolymer, ethylene/maleic anhydride/acrylate copolymer, ethylene/maleic anhydride/acrylate ester copolymer, ethylene/acrylate copolymer, ethylene/acrylate ester copolymer, ethylene/methacrylate copolymer, ethylene/vinyl acetate copolymer, and ionomer, and a melt end temperature of the adhesive layer is over a usage temperature of said plastic layer and less than a melt start temperature.

(4) A plastic lined steel pipe as set forth in any one of the above (1) to (3), wherein an epoxy primer layer is provided between said steel pipe and said adhesive layer.

(5) A plastic lined steel pipe as set forth in any one of the above (1) to (4), wherein a primary anti-rust coating, a zinc rich paint coating, or a polyolefin coating is provided on the outer surface of said plastic lined steel pipe instead of galvanization.

(6) A method for producing a plastic lined steel pipe as set forth in any one of the above (1) to (5), comprising, when producing said plastic lined steel pipe, applying substrate treatment to a steel pipe or applying substrate treatment to a steel pipe, then applying an epoxy primer layer, inserting a plastic pipe having an outside diameter smaller than the inside diameter of the steel pipe and having an adhesive layer on its outer surface into said steel pipe, drawing the steel pipe so as to make the plastic pipe come in close contact with the steel pipe, then heating the result at a temperature not less than a melt end temperature of the adhesive layer and less than a melt start temperature of the plastic pipe.

(7) A method for producing a plastic lined steel pipe as set forth in the above (6) further comprising, when drawing said steel pipe, drawing the steel pipe so that the outside diameter of the plastic pipe is reduced by 0.5 to 10%.

### BEST MODE FOR WORKING THE INVENTION

When producing the plastic lined steel pipe of the present invention, first the inner surface of the steel pipe is degreased and pickled or blasted to clean it. This steel pipe may be treated on its outer surface with hot dip galvanization or other plating. One with an outside diameter of about 10 to 2000 mm, usually about 20 to 170 mm, is used.

Next, the inventors discovered that if applying, as the substrate treatment of the steel pipe, a phosphate chemical treatment coating treated for grain refinement to reinforce its adhesion strength, even if the plastic pipe tries to shrink further at a cold location and the peeling force becomes larger, the chemical treatment coating will never fail to withstand this and end up breaking. Further, they discovered that the finder the grains of the phosphate of the chemical treatment coating, the more improved the adhesion strength. As the chemical treatment solution, a mixture comprised of for example phosphoric acid, nitric acid, zinc oxide, and calcium carbonate and water and adjusted in pH by sodium hydroxide (calcium zinc phosphate treatment solution) is used. Calcium zinc phosphate is excellent in heat resistance, so is preferred for the present invention which is accompanied with heating in the production. A good waterproof adhesion is obtained, when the amounts of addition of these are 8 to 15 g/L as phosphoric acid ions, 30 to 60 g/L as nitric acid ions, 2 to 4 g/L as zinc ions, 5 to 10 g/L as calcium ions, and the pH is in the range of 2.0 to 2.5. As a representative calcium zinc phosphate treatment solution corresponding to the above composition, there is Palbond P (made by Nihon Parkerizing Co. Ltd.)

In the coating of the chemical treatment coating, the steel pipe may be coated with the above chemical treatment solution by dipping, injection into the steel pipe, or spraying, then heated and dried by hot air heating, high frequency induction heating, etc. The amount of deposition of this chemical treatment coating is preferably about 1 to 10 g/m². If the deposition amount thereof is less than 1 g/m², the chemical treatment coating will not completely cover the iron surface, while if it is over 10 g/m², brittle secondary crystal grains will grow in the chemical treatment coating, so the waterproof adhesion strength of the plastic lining layer will be lowered.

The grain refinement is carried out, before coating the chemical treatment coating, by dip coating, insertion coating, or spray coating the steel pipe with for example a treatment solution obtained by dispersing titanium colloid in water in a range of from 1 to 5 g/L (as representative example, there is Prepalene Z (made by Nihon Parkerizing Co. Ltd.)) and/or adding to the above chemical treatment solution for example basic nickel carbonate as the nickel ions in a range of from 0.2 to 1.0 g/L. The titanium or nickel forms cores for the precipitation of crystal grains of the phosphate and densely adhere to the iron surface to refine the grains, therefore the contact area between the crystal grains and the iron increases and the adhesion strength is improved. If not performing the grain refinement, crystal grains having a size of over 10 μm will be generated, but if performing the grain refinement, the crystal grains will be refined to a size of 10 μm or less, therefore the adhesion strength is improved three-fold or more. If the amounts added are less than the lower limits, the effect of the grain refinement will be lowered, while if over the upper limits, the economicalness will deteriorate.

After this, a plastic pipe having an outside diameter smaller than the inside diameter of the steel pipe and longer than the length of the steel pipe is inserted into the steel pipe, the steel pipe is roll drawn, strike drawn, or die drawn so that the outside diameter of the plastic pipe is reduced by 0.5 to 10% to thereby make the plastic pipe closely contact the inner surface of the steel pipe. If the reduction ratio of this plastic pipe is less than 0.5%, the expansion force of the plastic pipe becomes small, so the adhesion strength of the plastic lining layer will be lowered. If the reduction ratio of the plastic pipe is over 10%, the plastic pipe will deform, so the adhesion with the inner surface of the steel pipe will be degraded.

As the plastic pipe used in the present invention, use is made of a plastic pipe made of a polyolefin resin or a cross-linked polyolefin resin. As the polyolefin resin, use is made of an ethylene homopolymer or an ethylene/α-olefin copolymer obtained by copolymerizing ethylene and propylene, 1-butene, 1-hexene, 1-octene, or another α-olefin or a mixture of the same into which additives such as an antioxidant, UV absorbent, fire retardant, pigment, filler, lubricant, antistatic agent and other resins are mixed according to need within a range not impairing the performance of the present invention.

As the cross-linked polyolefin resin, use is made of a polyolefin resin which is cross-linked by using a radical generator or a silane-modified polyolefin resin which is water cross-linked (silane cross-linked). As the radical generator, use is made of an organic peroxide such as dicumyl peroxide, benzoyl peroxide, di-t-butyl peroxide, or 2,5-dimethyl-2,5-di(t-butylperoxy)hexane. Further, other than the above organic peroxides, use can be also made of an azo compound such as azoisobutylonitrile. The silane modification is carried out by graft reacting an ethylenic unsaturated silane compound with the polyolefin resin in the presence of the radical generator. Here, the ethylenic unsaturated silane compound is represented by the following general formula:
RSiR′ₙY₃₋ₙ
wherein, R represents an ethylenic unsaturated hydrocarbon group or hydrocarbon oxy group, R′ represents an aliphatic saturated hydrocarbon group, Y represents an organic group which can be hydrolyzed, and n represents 0 to 2.

Specifically, vinyl trimethoxysilane, vinyl triethoxysilane, vinyl triacetoxysilane, etc. is used. This silane modification may be carried out in advance by an extruder etc. or may be carried out by at the time of shaping by charging the stock ingredients from a hopper and performing it at the kneading portion of the shaping machine. The cross-linking reaction is carried out by heat treatment, water treatment, etc. at the time of the extrusion and/or shaping. In the case of a silane-modified polyolefin resin, in order to improve the cross-linking speed, a silanol condensation catalyst is preferably used together. This may be mixed in at the time of the shaping or coated after the shaping. As the silanol condensation catalyst, dibutyl tin dilaurate, dioctyl tin dilaurate, cobalt naphthenate, toluene sulfonic acid, etc. can be used. The cross-linked polyolefin resin used in the present invention may have added to it, within a range not impairing the performance of the present invention, an additive such as an antioxidant, UV absorbent, fire retardant, pigment, filler, lubricant, or antistatic agent or other resin according to need.

As the method of preparation of the plastic pipe used in the present invention, a resin is extruded in the form of a pipe using an extruder or the like from a round die having an outside diameter smaller than the inside diameter of the steel pipe to be lined, then cooled to fix its shape. The thickness of this plastic pipe can be freely set according to need. It is not particularly limited, but usually a pipe of a thickness of 0.3 mm to 10 mm, preferably 0.5 mm to 5 mm, is used. Further, in order to improve the adhesion strength with the adhesive layer, after shaping the plastic pipe, according to need, the outer surface may be coated by a commercially available primer, oxidized, or roughened.

A steel pipe and a plastic pipe do not have much adhesiveness, so an adhesive layer is desirably provided between them. Especially, it was found that by forming the adhesive layer by a material comprised of one or two or more of a maleic anhydride-modified polyolefin, itaconic anhydride-modified polyolefin, ethylene/maleic anhydride copolymer, ethylene/maleic anhydride/acrylate copolymer, ethylene/maleic anhydride/acrylate ester copolymer, ethylene/acrylate copolymer, ethylene/acrylate ester copolymer, ethylene/methacrylate copolymer, ethylene/vinyl acetate copolymer, and ionomer and having a melt end temperature less than the melt start temperature of the plastic pipe and over the usage temperature of the plastic pipe, an adhesion strength far superior to that of other materials is manifested. As the polyolefin of an adhesive layer made of a maleic anhydride-modified polyolefin, use is made of for example a low crystallinity ethylene-based polymer having a melt end temperature of 100° C. If the melt end temperature is not less than the melt start temperature of the plastic pipe, it is necessary to perform heating at a temperature not less than the melt start temperature of the plastic pipe for manifesting the adhesion strength, therefore the plastic pipe will soften, the expansion force will be lost, the pipe will deform. Further, if the melt end temperature is not more than the usage temperature, the adhesive layer will completely melt during use, so the adhesion strength of the plastic lining layer will be lowered.

The adhesive layer is coated by coextruding the adhesive layer onto the outer surface of the plastic pipe at the time of shaping the plastic pipe using a two-layer round die having an outside diameter smaller than the inside diameter of the steel pipe to be lined or by coextruding the adhesive layer after shaping the plastic pipe by using a round die or T-die. Further, in order to manifest the adhesion strength, after roll drawing, forge drawing, or die drawing the steel pipe, the pipe is heated at a temperature not less than the melt end temperature of the adhesive layer and less than the melt start temperature of the plastic pipe by hot air heating, high frequency induction heating, etc. If the heating temperature is less than the melt end temperature of the adhesive layer, the adhesive layer will not be completely melted, so the adhesion strength will not be manifested. Further, if the heating temperature is the melt start temperature of the plastic pipe or more, the plastic pipe will soften, the expansion force will be lost, and the pipe will deform. The thickness of this adhesive layer can be freely set according to need. It is not particularly limited, but usually a thickness of 1 μm to 3 mm, preferably 10 μm to 1.5 mm, is used.

If there is an epoxy primer layer between the steel pipe and the adhesive layer, a good waterproof adhesiveness is obtained, so this is desirable. As the epoxy primer layer, a mixture formed by for example an epoxy, a pigment, an additive, and a curing agent (epoxy resin powder primer) is used. As the epoxy, for example, a diglycidyl ether of bisphenol A, a diglycidyl ether of bisphenol F, or a phenol novolac type or cresol novolac type glycidyl ether is used. These epoxys can be used alone or can be used mixed together according to the object. As the pigment, a fine powder of silica, barium sulfate, calcium carbonate, or other extender pigment or titanium oxide, carbon black, or other coloring pigment is used. A good waterproof adhesiveness is obtained when the amount added of these pigments is within a range of from 3 to 50 parts by weight with respect to 100 parts by weight of the epoxy. As the additive, use can be made of an acryl oligomer, fine powder silica or the like.

As the curing agent, a dibasic acid such as dicyandiamide or decane dicarbonate, a hydrazine such as adipic acid dihydrazide, an acid anhydride such as tetrahydrophthalate anhydride, a phenol-based curing agent obtained by adding bisphenol A to a diglycidyl ether of bisphenol A, or an amine adduct obtained by adding diamide diphenylmethane to a diglycidyl ether of the bisphenol A can be used. If using a dibasic acid, hydrazine, or phenol-based curing agent for the curing agent, the amount of the curing agent is determined by the ratio between the equivalent weight of the epoxy and the equivalent weight of the active hydrogen of the curing agent. As the equivalent weight ratio, an 0.6 to 1.2 equivalent weight of the active hydrogen with respect to an 1.0 equivalent weight of epoxy is good.

If using dicyandiamide as the curing agent, in order to lower the curing temperature, a modified imidazole is added as the curing accelerator. As this modified imidazole, for example 2-methylimidazole, 2-phenylimidazole, etc. can be utilized. For the blending of the curing agent in this case, a good waterproof adhesiveness is obtained if dicyandiamide is added in a range of from 3 to 10 parts by weight with respect to 100 parts by weight of the epoxy and the modified imidazole is added in a range of from 0.1 to 3 parts by weight with respect to 100 parts by weight of the epoxy. Similarly, even if using a phenol-based curing agent, a modified imidazole is effectively used as the curing accelerator. As a representative epoxy resin powder paint corresponding to the above composition, there is Powdax E (made by Nippon Paint Co. Ltd.)

The epoxy primer layer may be coated by electrostatic spray coating or fluid suction coating the epoxy primer layer on the inner surface of the steel pipe at room temperature to about 80° C, then heating the steel pipe to cure the layer at about 140 to 220° C. by hot air heating or high frequency induction heating. The thickness of this epoxy primer layer is preferably 40 to 600 μm. If the thickness is less than 40 μm, there is possibility that the thickness become the film forming limit of the powder coating or less, so continuous coating will not be carried out and therefore the waterproof adhesion strength of the plastic lining layer will be lowered. Further, from the viewpoints of work efficiency and economy, the upper limit of the thickness is preferably about 600 μm.

It is also possible to provide the outer surface of the inner surface plastic lined steel pipe with a primary anti-rust coating, zinc rich paint coating, or polyolefin coating in place of the galvanization. As the primary anti-rust coating, a general commercially available alkyd-based or epoxy-based paint etc. is coated to a thickness of about 20 to 30 μm. As the zinc rich paint coating, a general commercially available organic or inorganic zinc rich paint etc. is coated to a thickness of about 65 to 85 μm. Further, in order to improve the corrosion resistance, it is also possible to coat a commercially available clear paint, white rust prevention paint, or the like according to need after coating the zinc rich paint. If using a polyolefin coating, first the outer surface of the steel pipe is degreased and blasted or pickled to clean it. Thereafter, the adhesive and the polyolefin resin are sequentially coated.

As the adhesive, a material comprised of one or two or more of a maleic anhydride-modified polyolefin, itaconic anhydride-modified polyolefin, ethylene/maleic anhydride copolymer, ethylene/maleic anhydride/acrylate copolymer, ethylene/maleic anhydride/acrylate ester copolymer, ethylene/acrylate copolymer, ethylene/acrylate ester copolymer, ethylene/methacrylate copolymer, ethylene/vinyl acetate copolymer, and ionomer is used. As the rate of addition of the maleic anhydride, a good adhesion strength is obtained when it is added within the range of from 0.05 to 0.5 wt %.

The adhesive is coated by extrusion onto the outer surface of the steel pipe by using a round die or T-die. When the thickness of this adhesive is about 80 to 400 μm, a good adhesion strength is obtained.

As the polyolefin resin, an ethylene homopolymer or an ethylene/α-olefin copolymer obtained by copolymerizing ethylene and propylene, 1-butene, 1-hexene, 1-octene, or another α-olefin or a mixture of the same including, according to need, an additive such as an antioxidant, UV absorbent, fire retardant, pigment, filler, lubricant, or antistatic agent and another resin is used.

These polyolefin resins are coated by extrusion onto the outer surface of a steel pipe coated with an adhesive by using a round die or T-die, but the method of using a two-layer round die or two-layer T die and coextruding the adhesive and the polyolefin resin for coating can also be used. When the thickness of this polyolefin resin is about 0.3 to 10 μm, a good anti-corrosion property is obtained.

Further, when there is a chemical treatment coating or epoxy primer between the steel pipe and the adhesive, a good waterproof adhesiveness is obtained, so this is desirable. As the chemical treatment solution, a mixture comprised of for example phosphoric acid, nitric acid, zinc oxide, calcium carbonate and water and adjusted in pH by sodium hydroxide (calcium zinc phosphate treatment solution) is used. In the coating of the chemical treatment coating, the steel pipe may be coated with the above chemical treatment solution by spraying or dipping, then heated and dried by high frequency induction heating, hot air heating, etc. The amount of deposition of this chemical treatment coating is preferably about 1 to 10 g/m². If the deposition amount thereof is less than 1 g/m² or over 10 g/m², the waterproof adhesion strength of the polyolefin coating will be lowered. Further, grain refinement may also be performed.

As the epoxy primer, for example an epoxy resin powder primer is used. The epoxy primer layer may be coated by pre-heating the steel pipe given the chemical treatment coating by high frequency induction heating or hot air heating, then electrostatic spray coating or fluid suction coating the epoxy primer layer on the surface. The thickness of this epoxy primer layer is preferably 40 to 600 μm. If the thickness is less than 40 μm, the waterproof adhesion strength of the polyolefin coating is lowered. Further, from the viewpoints of the work efficiency and economy, the upper limit of the thickness is preferably about 600 μm.

The present invention will be explained in detail next based on examples.

### EXAMPLE 1

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m², and the average grain size thereof was about 5 μm. Next, using a two-layer round die, when shaping a polyethylene plastic pipe (melt start temperature of 120° C.) having an outside diameter of 42.2 mm, a thickness of 1.5 mm, and a length of 4040 mm, an adhesive made of a maleic anhydride-modified polyethylene (melt end temperature: 100° C.) was coated on the outer surface by coextrusion so as to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 2

The inner surface of the steel pipe hot dip galvanized on its outer surface and having an outside diameter of 50.8 mm, a thickness of 3.3 mm, and a length of 3930 mm was degreased by a commercially available alkali degreasing agent and pickled to remove the rust, then successively injected with a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.), and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, and the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off.

### EXAMPLE 3

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 4

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, and the result was heated to 180° C. in hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm. (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 5

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 m, and a length of 4040 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off.

The outer surface of the inner surface plastic lined steel pipe was degreased by a commercially available alkali degreasing agent, grit blasted to remove the rust, then coated with a calcium zinc phosphate treatment solution by spraying and heated to a steel pipe surface temperature of 115° C. by high frequency induction heating to form a chemical treatment coating. The amount of deposition of the chemical treatment coating was 4 g/m². Immediately after that, using a two-layer round die, a maleic anhydride-modified polyethylene adhesive and a polyethylene resin were coated by coextrusion. The thicknesses of the maleic anhydride-modified polyethylene adhesive and the polyethylene resin were 200 μm and 1.0 mm.

### EXAMPLE 6

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of an itaconic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 7

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of the ethylene/maleic anhydride copolymer (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 8

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of an ethylene/maleic anhydride/acrylate copolymer (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 9

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of the ethylene/maleic anhydride/acrylate ester copolymer (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 10

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of the ethylene/acrylate copolymer (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 11

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of the ethylene/acrylate ester copolymer (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 12

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of an ethylene/methacrylate copolymer (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 13

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of the ethylene/vinyl acetate copolymer (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 14

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of an ionomer (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available organic zinc rich paint to a thickness of 75 μm and further coated with a commercially available clear paint to a thickness of 30 μm.

### EXAMPLE 15

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of the maleic anhydride-modified copolymer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 16

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form-a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 17

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of an itaconic anhydride-modified polyethylene (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit-blasted to remove the rust, then coated with a commercially available alkyd-based paint to a thickness of 25 μm.

### EXAMPLE 18

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of the ethylene/maleic anhydride copolymer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 19

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of an ethylene/maleic anhydride/acrylate copolymer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 20

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of an ethylene/maleic anhydride/acrylate ester copolymer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 21

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of the ethylene/acrylate copolymer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 22

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of an ethylene/acrylate ester copolymer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 23

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of an ethylene/methacrylate copolymer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 24

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of an ethylene/vinyl acetate copolymer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### EXAMPLE 25

A steel pipe having an outside diameter of 50.8 mm, a thickness of 3.3 mm, and a length of 3930 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of an ionomer (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The cross-linked polyethylene plastic pipe protruding from the end portion of the steel pipe was cut off. The outer surface of this inner surface plastic lined steel pipe was degreased by a commercially available alkali degreasing agent, grit blasted to remove the rust, then coated with a commercially available alkyd-based paint to a thickness of 25 μm.

### COMPARATIVE EXAMPLE 1

A steel pipe having an outside diameter of 34.0 mm, a thickness of 3.2 mm, and a length of 4000 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing Co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe (melt start temperature: 120° C.), an adhesive made of a maleic anhydride-modified polyethylene (melt end temperature: 130° C.) was coated on the outer surface by co-extrusion to form an adhesive layer, then the pipe was drawn so as to be reduced by 13% in the diameter direction so as to prepare a polyethylene plastic pipe having an outside diameter of 26.1 mm, a thickness of 1.5 mm, and a length of 4500 mm. The thickness of the adhesive layer was 200 μm.

Thereafter, the polyethylene plastic pipe was inserted into the steel pipe and the result was heated to a steel pipe surface temperature of 200° C. by high frequency induction heating so as to restore the polyethylene plastic pipe in shape. The part of the polyethylene plastic pipe protruding from the end portion of the steel pipe was cut off.

### COMPARATIVE EXAMPLE 2

A steel pipe having an outside diameter of 34.0 mm, a thickness of 3.2 mm, and a length of 4000 mm was degreased by a commercially available alkali degreasing agent and pickled to remove the rust, then the steel pipe was dipped in the calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, at the time of the shaping of the polyethylene plastic pipe (melt start -temperature: 120° C.), an adhesive made of a maleic anhydride-modified polyethylene (melt end temperature: 130° C.) was coated on the outer surface by co-extrusion to form an adhesive layer, then the pipe was drawn so as to be reduced by 13% in the diameter direction so as to prepare a polyethylene plastic pipe having an outside diameter of 26.1 mm, a thickness of 1.5 mm, and a length of 4500 mm. The thickness of the adhesive layer was 200 μm.

Thereafter, the polyethylene plastic pipe was inserted into the steel pipe and the result was heated to a steel pipe surface temperature of 200° C. by high frequency induction heating to restore the polyethylene plastic pipe in shape. The part of the polyethylene plastic pipe protruding from the end portion of the steel pipe was cut off.

### COMPARATIVE EXAMPLE 3

A steel pipe having an outside diameter of 34.0 mm, a thickness of 3.2 mm, and a length of 4000 mm was degreased by a commercially available alkali degreasing agent and pickled to remove the rust, then the steel pipe was sequentially dipped in a treatment solution obtained by dispersing titanium colloid in water (Prepalene Z made by Nihon Parkerizing co. Ltd.) and a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, at the time of shaping a cross-linked polyethylene plastic pipe (melt start temperature: 120° C.), an adhesive made of a maleic anhydride-modified polyethylene (melt end temperature: 130° C.) was coated on the outer surface by coextrusion to form an adhesive layer, then the pipe was drawn so as to be reduced by 30% in the diameter direction so as to prepare a cross-linked polyethylene plastic pipe having an outside diameter of 26.1 mm, a thickness of 1.5 mm, and a length of 4500 mm. The thickness of the adhesive layer was 200 μm.

Thereafter, the cross-linked polyethylene plastic pipe was inserted into the steel pipe and the result was heated to a steel pipe surface temperature of 200° C. by high frequency induction heating so as to restore the cross-linked polyethylene plastic pipe in shape. The part of the cross-linked polyethylene plastic pipe protruding from the end portion of the steel pipe was cut off.

### COMPARATIVE EXAMPLE 4

A steel pipe having an outside diameter of 34.0 mm, a thickness of 3.2 mm, and a length of 4000 mm was degreased by a commercially available alkali degreasing agent and pickled to remove the rust, then the steel pipe was dipped in a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, at the time of shaping a cross-linked polyethylene plastic pipe (melt start temperature: 120° C.), an adhesive made of a maleic anhydride-modified polyethylene (melt end temperature: 130° C.) was coated on the outer surface by co-extrusion to form an adhesive layer, then the pipe was drawn so as to be reduced by 30% in the diameter direction so as to prepare a cross-linked polyethylene plastic pipe having an outside diameter of 26.1 mm, a thickness of 1.5 mm, and a length of 4500 mm. The thickness of the adhesive layer was 200 μm.

Thereafter, the cross-linked polyethylene plastic pipe was inserted into the steel pipe and the result was heated to a steel pipe surface temperature of 200° C. by high frequency induction heating so as to restore the cross-linked polyethylene plastic pipe in shape. The part of the cross-linked polyethylene plastic pipe protruding from the end portion of the steel pipe was cut off.

### COMPARATIVE EXAMPLE 5

A steel pipe having an outside diameter of 50.8 mm, a thickness of 3.3 mm, and a length of 3930 mm was degreased by a commercially available alkali degreasing agent and pickled to remove the rust, then the steel pipe was dipped in a calcium zinc phosphate treatment solution (Palbond P made by Nihon Parkerizing Co. Ltd.) and dried by hot air heating to form a chemical treatment coating. The amount of deposition of the chemical treatment coating was 4 g/m², and the mean grain size thereof was about 15 μm. Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a polyethylene plastic pipe having an outside diameter of 42.4 mm, a thickness of 1.5 mm, and a length of 4040 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the polyethylene plastic pipe was inserted into the steel pipe and the steel pipe was roll drawn so that the outside diameter of the polyethylene plastic pipe was reduced by 1.4%, whereby the polyethylene plastic pipe was made to closely contact the inner surface of the steel pipe, then the result was heated to 115° C. in a hot air heating furnace. The part of the polyethylene plastic pipe protruding from the end portion of the steel pipe was cut off.

### COMPARATIVE EXAMPLE 6

A steel pipe having an outside diameter of 50.8 mm, a thickness of 3.3 mm, and a length of 3930 mm was degreased by a commercially available alkali degreasing agent and pickled to remove the rust, then the steel pipe was dipped in a calcium zinc phosphate treatment solution (Palbond P made by Nihon Parkerizing Co. Ltd.) and dried by hot air heating to form a chemical treatment coating. The amount of deposition of the chemical treatment coating was 4 g/m². Next, an epoxy resin powder primer (Powdax E made by Nippon Paint Co. Ltd.) was coated on the inner surface of the steel pipe at room temperature by electrostatic spraying, then the result was heated to 180° C. in a hot air heating furnace to form an epoxy primer layer. The thickness of the epoxy primer layer was 100 μm. Further, using a two-layer round die, when shaping a cross-linked polyethylene plastic pipe having an outside diameter of 42.4 mm, a thickness of 1.5 mm, and a length of 4040 mm (melt start temperature of 120° C.), an adhesive made of a maleic anhydride-modified polyethylene (melt end temperature: 100° C.) was coated on the outer surface by coextrusion to form an adhesive layer. The thickness of the adhesive layer was 200 μm.

Thereafter, the cross-linked polyethylene plastic pipe was inserted into the steel pipe and the steel pipe was roll drawn so that the outside diameter of the cross-linked polyethylene plastic pipe was reduced by 1.4%, whereby the cross-linked polyethylene plastic pipe was made to closely contact the inner surface of the steel pipe, then the result was heated to 115° C. in a hot air heating furnace. The part of the cross-linked polyethylene plastic pipe protruding from the end portion of the steel pipe was cut off.

The plastic lined steel pipes of Examples 1 to 15 and Comparative Examples 1 to 6 were measured for the shearing adhesion strength between the steel pipe and the plastic pipe of the inner surface. The shearing adhesion strength was measured by cutting each produced plastic lined steel pipes to pieces having lengths of 20 mm, supporting only the steel pipe portions by using a jig, and pushing out only the plastic lining layers of the inner surface under conditions of 10 mm/min. The shearing adhesion strength was found by the pushing force at this time. Three samples were extracted from each plastic lined steel pipe, and the mean value was found. The unit of the shearing adhesion strength is MPa. The temperature during the measurement was uniformly set to 23° C. Also, the shearing adhesion strengths after warm water of 60° C. and hot water of 95° C. were passed through the plastic lined steel pipes for one year were measured together. The conditions and measurement results of the examples are shown in Tables 1a, 1b, 2a, 2b, 3a, 3b, 4a, and 4b.

The initial shearing adhesion strengths of Examples 1 to 25 were all more than 2.0 MPa and high values of the preferable range of 4.0 MPa. It is also learned that the shearing adhesion strengths after warm water of 60° C. and hot water of 95° C. were passed through the plastic lined steel pipes for one year were remarkably high in comparison with Comparative Examples 1 to 4.

Further, freezing/thawing tests envisioning use at cold locations were carried out on the plastic lined steel pipes of the examples and the comparative examples. The freezing/thawing tests were carried out by cutting the produced plastic lined steel pipes to pieces having lengths of 150 mm, standing them up in vessels filled with tap water to immerse them up to about ⅓, placing the vessels in an isothermal tank and freezing them so that the temperature became −20° C., then taking these out and placing in an isothermal tank and thawing them so that the temperature became 60° C. This operation was repeated 1500 times. The numbers of times until peeling of the plastic lining layers of the inner surfaces were measured. The measurement results thereof are also shown in Tables 1b, 2b, 3b, and 4b.

In all of Examples 1 to 25, no peeling occurred at the plastic lining layer of the inner surface, but in Comparative Examples 1 to 6, peeling occurred at the plastic lining layer of the inner surface after a small number of times of this operation.

TABLE 1a

| | Steel pipe inner surface | | | |
|---|---|---|---|---|
| | | | Substrate | Steel pipe |
| Ex- | Plastic | | treatment | outer |
| amples | layer | Adhesive layer | etc. | surface |
| Ex- | Poly- | Maleic | Calcium zinc | Zinc rich |
| ample 1 | ethylene | anhydride-modified | phosphate* | paint coating |
| | resin | polyethylene | | |
| Ex- | Poly- | Maleic | Calcium zinc | Galvanization |
| ample 2 | ethylene | anhydride-modified | phosphate* + | |
| | resin | polyethylene | epoxy resin | |
| | | | powder primer | |
| Ex- | Poly- | Maleic | Calcium zinc | Primary anti- |
| ample 3 | ethylene | anhydride-modified | phosphate* + | rust coating |
| | resin | polyethylene | epoxy resin | |
| | | | powder primer | |
| Ex- | Poly- | Maleic | Calcium zinc | Zinc rich |
| ample 4 | ethylene | anhydride-modified | phosphate* + | paint coating |
| | resin | polyethylene | epoxy resin | |
| | | | powder primer | |
| Ex- | Poly- | Maleic | Calcium zinc | Polyethylene |
| ample 5 | ethylene | anhydride-modified | phosphate* + | coating |
| | resin | polyethylene | epoxy resin | |
| | | | powder primer | |

*With treatment for grain refinement

TABLE 1b

| | Shearing adhesion strength (MPa) | | | |
|---|---|---|---|---|
| | | After | After | Freezing/ |
| | | carrying 60° C. | carrying 95° C. | thawing test |
| | | warm water | hot water for | Times until |
| Examples | Initial | for 1 year | 1 year | peeling |
| Example 1 | 4.0 | 3.6 | 3.2 | No peeling |
| | | | | after 1500X |
| Example 2 | 4.0 | 3.8 | 3.6 | No peeling |
| | | | | after 1500X |
| Example 3 | 4.0 | 3.8 | 3.6 | No peeling |
| | | | | after 1500X |
| Example 4 | 4.0 | 3.8 | 3.6 | No peeling |
| | | | | after 1500X |
| Example 5 | 4.0 | 3.8 | 3.6 | No peeling |
| | | | | after 1500X |

TABLE 2a

| | Steel pipe inner surface | | | |
|---|---|---|---|---|
| | | | Substrate | Steel pipe |
| Ex- | Plastic | | treatment | outer |
| amples | layer | Adhesive layer | etc. | surface |
| Ex- | Poly- | Itaconic anhydride- | Calcium zinc | Zinc rich |
| ample 6 | ethylene | modified | phosphate* + | paint |
| | resin | polyethylene | epoxy resin | coating |
| | | | powder primer | |
| Ex- | Poly- | Ethylene/maleic | Calcium zinc | Zinc rich |
| ample 7 | ethylene | anhydride | phosphate* + | paint |
| | resin | copolymer | epoxy resin | coating |
| | | | powder primer | |
| Ex- | Poly- | Ethylene/maleic | Calcium zinc | Zinc rich |
| ample 8 | ethylene | anhydride/acrylate | phosphate* + | paint |
| | resin | copolymer | epoxy resin | coating |
| | | | powder primer | |
| Ex- | Poly- | Ethylene/maleic | calcium zinc | Zinc rich |
| ample 9 | ethylene | anhydride/acrylate | phosphate* + | paint |
| | resin | ester copolymer | epoxy resin | coating |
| | | | powder primer | |
| Ex- | Poly- | Ethylene/acrylate | Calcium zinc | Zinc rich |
| ample | ethylene | copolymer | phosphate* + | paint |
| 10 | resin | | epoxy resin | coating |
| | | | powder primer | |
| Ex- | Poly- | Ethylene/acrylate | Calcium zinc | Zinc rich |
| ample | ethylene | ester copolymer | phosphate* + | paint |
| 11 | resin | | epoxy resin | coating |
| | | | powder primer | |
| Ex- | Poly- | Ethylene/ | Calcium zinc | Zinc rich |
| ample | ethylene | methacrylate | phosphate* + | paint |
| 12 | resin | copolymer | epoxy resin | coating |
| | | | powder primer | |
| Ex- | Poly- | Ethylene/vinyl | Calcium zinc | Zinc rich |
| ample | ethylene | acetate copolymer | phosphate* + | paint |
| 13 | resin | | epoxy resin | coating |
| | | | powder primer | |
| Ex- | Poly- | Ionomer | Calcium zinc | Zinc rich |
| ample | ethylene | | phosphate* + | paint |
| 14 | resin | | epoxy resin | coating |
| | | | powder primer | |

*With treatment for grain refinement

TABLE 2b

| | Shearing adhesion strength (MPa) | | | |
|---|---|---|---|---|
| | | After | After | Freezing/ |
| | | carrying 60° C. | carrying 95° C. | thawing test |
| | | warm water | hot water for | Times until |
| Examples | Initial | for 1 year | 1 year | peeling |
| Example 6 | 4.0 | 3.6 | 3.2 | No peeling |
| | | | | after 1500X |
| Example 7 | 4.0 | 3.8 | 3.6 | No peeling |
| | | | | after 1500X |
| Example 8 | 4.0 | 3.8 | 3.6 | No peeling |
| | | | | after 1500X |
| Example 9 | 4.0 | 3.8 | 3.6 | No peeling |
| | | | | after 1500X |
| Example 10 | 4.0 | 3.8 | 3.6 | No peeling |
| | | | | after 1500X |
| Example 11 | 4.0 | 3.8 | 3.6 | No peeling |
| | | | | after 1500X |
| Example 12 | 4.0 | 3.8 | 3.6 | No peeling |
| | | | | after 1500X |
| Example 13 | 4.0 | 3.8 | 3.6 | No peeling |
| | | | | after 1500X |
| Example 14 | 4.0 | 3.8 | 3.6 | No peeling |
| | | | | after 1500X |

TABLE 3a

| | Steel pipe inner surface | | | |
|---|---|---|---|---|
| | | | Substrate | Steel pipe |
| Ex- | Plastic | | treatment | outer |
| amples | layer | Adhesive layer | etc. | surface |
| Ex- | Cross- | Maleic | Calcium zinc | Primary |
| ample | linked | anhydride-modified | phosphate* + | anti-rust |
| 15 | poly- | polyethylene | epoxy resin | coating |
| | ethylene | | powder primer | |
| | resin | | | |
| Ex- | Cross- | Maleic | Calcium zinc | Primary |
| ample | linked | anhydride-modified | phosphate* + | anti-rust |
| 16 | poly- | polyethylene | epoxy resin | coating |
| | ethylene | | powder primer | |
| | resin | | | |
| Ex- | Cross- | Itaconic | Calcium zinc | Primary |
| ample | linked | anhydride-modified | phosphate* + | anti-rust |
| 17 | poly- | polyethylene | epoxy resin | coating |
| | ethylene | | powder primer | |
| | resin | | | |
| Ex- | Cross- | Ethylene/maleic | Calcium zinc | Primary |
| ample | linked | anhydride-modified | phosphate* + | anti-rust |
| 18 | poly- | | epoxy resin | coating |
| | ethylene | | powder primer | |
| | resin | | | |
| Ex- | Cross- | Ethylene/maleic | Calcium zinc | Primary |
| ample | linked | anhydride-modified | phosphate* + | anti-rust |
| 19 | poly- | copolymer | epoxy resin | coating |
| | ethylene | | powder primer | |
| | resin | | | |
| Ex- | Cross- | Ethylene/maleic | Calcium zinc | Primary |
| ample | linked | anhydride-modified | phosphate* + | anti-rust |
| 20 | poly- | ester copolymer | epoxy resin | coating |
| | ethylene | | powder primer | |
| | resin | | | |
| Ex- | Cross- | Ethylene/acrylate | Calcium zinc | Primary |
| ample | linked | copolymer | phosphate* + | anti-rust |
| 21 | poly- | | epoxy resin | coating |
| | ethylene | | powder primer | |
| | resin | | | |
| Ex- | Cross- | Ethylene/acrylate | Calcium zinc | Primary |
| ample | linked | ester copolymer | phosphate* + | anti-rust |
| 22 | poly- | | epoxy resin | coating |
| | ethylene | | powder primer | |
| | resin | | | |
| Ex- | Cross- | Ethylene/ | Calcium zinc | Primary |
| ample | linked | methacrylate | phosphate* + | anti-rust |
| 23 | poly- | copolymer | epoxy resin | coating |
| | ethylene | | powder primer | |
| | resin | | | |
| Ex- | Cross- | Ethylene/vinyl | Calcium zinc | Primary |
| ample | linked | acetate copolymer | phosphate* + | anti-rust |
| 24 | poly- | | epoxy resin | coating |
| | ethylene | | powder primer | |
| | resin | | | |
| Ex- | Cross- | Ionomer | Calcium zinc | Primary |
| ample | linked | | phosphate* + | anti-rust |
| 25 | poly- | | epoxy resin | coating |
| | ethylene | | powder primer | |
| | resin | | | |

*With treatment for grain refinement

TABLE 3b

| | Shearing adhesion strength (MPa) | | | |
|---|---|---|---|---|
| | | After | After | Freezing/ |
| | | carrying 60° C. | carrying 95° C. | thawing test |
| | | warm water | hot water for | Times until |
| Examples | Initial | for 1 year | 1 year | peeling |
| Example | 4.0 | 3.6 | 3.2 | No peeling |
| 15 | | | | after 1500X |
| Example | 4.0 | 3.8 | 3.6 | No peeling |
| 16 | | | | after 1500X |
| Example | 4.0 | 3.8 | 3.6 | No peeling |
| 17 | | | | after 1500X |
| Example | 4.0 | 3.8 | 3.6 | No peeling |
| 18 | | | | after 1500X |
| Example | 4.0 | 3.8 | 3.6 | No peeling |
| 19 | | | | after 1500X |
| Example | 4.0 | 3.8 | 3.6 | No peeling |
| 20 | | | | after 1500X |
| Example | 4.0 | 3.8 | 3.6 | No peeling |
| 21 | | | | after 1500X |
| Example | 4.0 | 3.8 | 3.6 | No peeling |
| 22 | | | | after 1500X |
| Example | 4.0 | 3.8 | 3.6 | No peeling |
| 23 | | | | after 1500X |
| Example | 4.0 | 3.8 | 3.6 | No peeling |
| 24 | | | | after 1500X |
| Example | 4.0 | 3.8 | 3.6 | No peeling |
| 25 | | | | after 1500X |

TABLE 4a

| | Steel pipe inner surface | | | |
|---|---|---|---|---|
| | | | Substrate | Steel pipe |
| Ex- | Plastic | | treatment | outer |
| amples | layer | Adhesive layer | etc. | surface |
| Comp. | Poly- | Maleic | Calcium zinc | — |
| Ex. 1 | ethylene | anhydride-modified | phosphate* + | |
| | resin | polyethylene | epoxy resin | |
| | | | powder primer | |
| Comp. | Poly- | Maleic | Calcium zinc | — |
| Ex. 2 | ethylene | anhydride-modified | phosphate** + | |
| | resin | polyethylene | epoxy resin | |
| | | | powder primer | |
| Comp. | Cross- | Maleic | Calcium zinc | — |
| Ex. 3 | linked | anhydride-modified | phosphate* + | |
| | poly- | polyethylene | epoxy resin | |
| | ethylene | | powder primer | |
| | resin | | | |
| Comp. | Cross- | Maleic | Calcium zinc | — |
| Ex. 4 | linked | anhydride-modified | phosphate** + | |
| | poly- | polyethylene | epoxy resin | |
| | ethylene | | powder primer | |
| | resin | | | |
| Comp. | Poly- | Maleic | Calcium zinc | — |
| Ex. 5 | ethylene | anhydride-modified | phosphate** + | |
| | resin | polyethylene | epoxy resin | |
| | | | powder primer | |
| Comp. | Cross- | Maleic | Calcium zinc | — |
| Ex. 6 | linked | anhydride-modified | phosphate** + | |
| | poly- | polyethylene | epoxy resin | |
| | ethylene | | powder primer | |
| | resin | | | |

*With treatment for grain refinement
**No treatment for grain refinement

TABLE 4b

| | Shearing adhesion strength (MPa) | | | |
|---|---|---|---|---|
| | | After | After | Freezing/ |
| | | carrying 60° C. | carrying 95° C. | thawing test |
| | | warm water | hot water for | Times until |
| Examples | Initial | for 1 year | 1 year | peeling |
| Comp. | 3.2 | 1.6 | 0.8 | No peeling |
| Ex. 1 | | | | after 300X |
| Comp. | 1.6 | 0.8 | 0.4 | Peeling |
| Ex. 2 | | | | after 150X |
| Comp. | 3.2 | 1.6 | 0.8 | Peeling |
| Ex. 3 | | | | after 300X |
| Comp. | 1.6 | 0.8 | 0.4 | Peeling |
| Ex. 4 | | | | after 150X |
| Comp. | 4.0 | 3.8 | 3.6 | Peeling |
| Ex. 5 | | | | after 500X |
| Comp. | 4.0 | 3.8 | 3.6 | Peeling |
| Ex. 6 | | | | after 500X |

It was learned from these tables that the plastic lined steel pipes of the present invention are excellent in adhesiveness between the steel pipe and the inner surface plastic lining layer over a long period even at cold locations.

### INDUSTRIAL APPLICABILITY

According to the present invention, by drawing the steel pipe to line the inside surface while leaving an expansion force whereby the outside diameter of the plastic pipe tends to become larger than the inside diameter of the steel pipe and further providing between the steel pipe and the plastic pipe an adhesive layer and a phosphate chemical treatment coating treated for grain refinement to reinforce the adhesion and providing an epoxy primer layer according to need, a plastic lined steel pipe excellent in the adhesion between the steel pipe and the inner surface plastic lining layer over a long period even at cold locations and usable for piping for water supply, hot water supply, air-conditioning, firefighting, drainage, etc. can be provided.

1. A plastic lined steel pipe characterized by having an adhesive layer on an inner surface of a steel pipe or a steel pipe galvanized on its outer surface, having a plastic layer on its further inner side, and having an initial shearing adhesion strength between the steel pipe and the plastic layer of 2.0 MPa or more, said steel pipe being a steel pipe given substrate treatment on its inner surface in advance, said substrate treatment comprising forming a phosphate chemical treatment coating treated for grain refinement.

2. A plastic lined steel pipe as set forth in claim 1, wherein said plastic layer is a polyolefin resin or a cross-linked polyolefin resin.

3. A plastic lined steel pipe as set forth in claim 1, wherein said adhesive layer is comprised of one or more of a maleic anhydride-modified polyolefin, itaconic anhydride-modified polyolefin, ethylene/maleic anhydride copolymer, ethylene/maleic anhydride/acrylate copolymer, ethylene/maleic anhydride/acrylate ester copolymer, ethylene/acrylate copolymer, ethylene/acrylate ester copolymer, ethylene/methacrylate copolymer, ethylene/vinyl acetate copolymer, and ionomer, and a melt end temperature of the adhesive layer is over a usage temperature of said plastic layer and less than a melt start temperature.

4. A plastic lined steel pipe as set forth in claim 1, wherein an epoxy primer layer is provided between said steel pipe and said adhesive layer.

5. A plastic lined steel pipe as set forth in claim 1, wherein a primary anti-rust coating, a zinc rich paint coating, or a polyolefin coating is provided on the outer surface of said plastic lined steel pipe instead of galvanization.

6. A method for producing a plastic lined steel pipe as set forth in claim 1, comprising, when producing said plastic lined steel pipe, applying substrate treatment to a steel pipe or applying substrate treatment to a steel pipe, then applying an epoxy primer layer, inserting a plastic pipe having an outside diameter smaller than the inside diameter of the steel pipe and having an adhesive layer on its outer surface into said steel pipe, drawing the steel pipe so as to make the plastic pipe come in close contact with the steel pipe, then heating the result at a temperature not less than a melt end temperature of the adhesive layer and less than a melt start temperature of the plastic pipe.

7. A method for producing a plastic lined steel pipe as set forth in claim 6, further comprising, when drawing said steel pipe, drawing the steel pipe so that the outside diameter of the plastic pipe is reduced by 0.5 to 10%.
